(19) United States
(12) Patent Application Publication
(10) Pub. No.: US 2013/0093334 A1
(43) Pub. Date: Apr. 18, 2013

(54) LAMPS AND ILLUMINATING SYSTEM

(71) Applicant: LEXTAR ELECTRONICS CORPORATION, Hsinchu (TW)

(72) Inventors: Feng-Ling Lin, Pingtung City (TW); Po-Shen Chen, New Taipei City (TW); Hui-Ying Chen, Hemei Township (TW); Chun-Kuang Chen, Taipei City (TW); Tung-Yu Chen, Tainan City (TW)

(73) Assignee: LEXTAR ELECTRONICS CORPORATION, Hsinchu (TW)

(21) Appl. No.: 13/653,563

(22) Filed: Oct. 17, 2012

(30) Foreign Application Priority Data
Oct. 17, 2011 (TW) 100219374

(51) Int. Cl. H05B 37/02

(52) U.S. Cl. 315/155; 315/307; 315/158

(57) ABSTRACT

A lamp comprising a light emitting device and a controller is disclosed. The controller receives a control signal from a handheld device and switches the light emitting device according to the control signal such that the light emitting device operates in a light emitting mode corresponding to the control signal, in which the control signal is generated by the handheld device according to real-time information.

### RELATED APPLICATIONS

This application claims priority to Taiwan Application Serial Number 100219374, filed Oct. 17, 2011, which is herein incorporated by reference.

### BACKGROUND

1. Field of Invention

The invention relates to an illuminating system. More particularly, the invention relates to an illuminating system having a scenario control function.

2. Description of Related Art

Currently, lamps or illuminating systems on the market are simply controlled to be switched on or off, or the number of lamp tubes or light emitting devices which are lightened in a lamp is switched by a switch. Conventional lamps only provide a certain luminance indoors and cannot realize any adaptive change according to the demand of users. By adding a mechanism for controlling luminance in certain conventional lamps, the users can manually control the lighting luminance of the lamps, but conventional lamps or illuminating systems are still lack of an automatic regulation mechanism which is used for regulating the luminance, the color temperature or other parameters.

### SUMMARY

An aspect of the invention provides an operation mode which can change lamps or illuminating systems dynamically according to real-time data. More particularly, a lamp or an illuminating system which can realize a corresponding scenario control according to real-time information from a handheld device is provided.

Other aspects and advantages of the invention can be further understood from technical features disclosed by the invention.

In order to achieve one or part or all of the aspects or other aspects, an embodiment of the invention provides a lamp including a light emitting device and a controller. The controller receives a control signal from a handheld device and switches the light emitting device according to the control signal such that the light emitting device operates in a light emitting mode corresponding to the control signal, in which the control signal is generated by the handheld device according to real-time information.

Another embodiment of the invention provides an illuminating system including a handheld device and a lamp. The handheld device generates a control signal according to received real-time information. The lamp includes a light emitting device and a controller. The controller receives the control signal and switches the light emitting device according to the control signal such that the light emitting device operates in a light emitting mode corresponding to the control signal.

### BRIEF DESCRIPTION OF THE DRAWINGS

FIG. 1 illustrates a schematic view of an illuminating system according to an embodiment of the invention.

FIG. 2 illustrates a schematic view of a lamp capable of dynamically changing a light emitting mode based on real-time data according to an embodiment of the invention.

FIG. 3 illustrates a schematic view of a handheld electronic device invention capable of dynamically changing a light emitting mode of a lamp based on real-time data according to an embodiment of the invention.

### DETAILED DESCRIPTION

The above and other technical contents, features and functions of the invention will be clearly presented in the detailed description of embodiments with reference to the accompanying drawings. Direction phrases stated in the following embodiments, such as above, below, left, right, front or back, are only directions with reference to the accompanying drawings. Therefore, the direction phrases are used for illustration instead of limiting the invention.

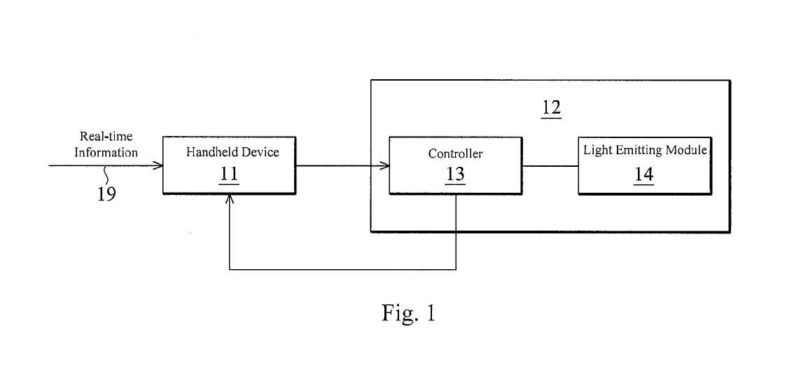

FIG. 1 illustrates a schematic view of an illuminating system according to an embodiment of the invention. A handheld device 11 receives real-time information 19, then generates and transmits a control signal to a lamp 12 according to the real-time information 19. A controller 13 receives the control signal and switches a light emitting module 14 to a light emitting mode corresponding to the control signal. According to the light emitting mode, the controller 13 regulates the light emitting time, luminance and color temperature of the light emitting module 14 or controls whether the light emitting module is conducted or not. The light emitting module 14 includes at least one cold color light emitting diode (LED) and at least one warm color LED. In this embodiment, the real-time information 19 may be weather information, and the handheld device 11 acquires the weather information via an application program and converts the weather information to a corresponding control signal. The handheld device 11 regulates the luminance of the light emitting module 14 according to the weather information of the current position of the lamp 12 or the handheld device 11. For example, in a sunny day, the handheld device 11 reduces the luminance of the light emitting module 14, and in a cloudy day, the handheld device 11 increases the luminance of the light emitting module 14.

In another embodiment, the real-time information 19 is a warning signal. The warning signal may come from a disaster warning system, an application program in the handheld device or a networked intelligent household appliance to warn a user. The controller 13 switches the light emitting mode of the light emitting module 14 to a flash mode and regulates the flash speed of the light emitting module 14 according to different warning signals. In yet another embodiment, the real-time information 19 is an alarm or a notification message of an application program of the handheld device 11, and the light emitting mode of the light emitting module 14 is switched to a flash mode according to the alarm or the notification message. The flash mode controls the cold color LED and the warm color LED in the light emitting module 14 to be conducted in an alternate order.

In still yet another embodiment, the real-time information 19 is time information, and the handheld device 11 determines a first light emitting mode according to the time information and generates a corresponding control signal. The controller 13 switches the light emitting mode of the light emitting module 14 to the first light emitting mode when receiving the control signal. In other words, the handheld device 11 generates a control signal corresponding to a light emitting mode to the lamp 12 in different times according to the setting of users.

A first sensing device is arranged in the handheld device 11 for sensing a first ambient light signal. The handheld device 11 generates a corresponding control signal according to the ambient light signal and the real-time information 19. In another embodiment, the lamp 12 further includes a second sensing device (not shown) for sensing second ambient light information and transmitting a feedback signal to the handheld device 11, so that the handheld device 11 generates and transmits the control signal according to the feedback signal and the real-time information 19.

In this embodiment, the signal is transmitted between the lamp 12 and the handheld device 11 via a wireless communication manner. The signal may be transmitted between the handheld device 11 and the controller 13 of the lamp 12 via microwave, infrared rays, radio wave, Bluetooth, 3G, 4G, WiMAX, ZIGBEE and other wireless communication transmission protocols. Similarly, the signal may also be transmitted between the second sensing device in the lamp 12 and the handheld device 11 via microwave, infrared rays, radio wave, Bluetooth, 3G, 4G, WiMAX, ZIGBEE and other wireless communication transmission protocols.

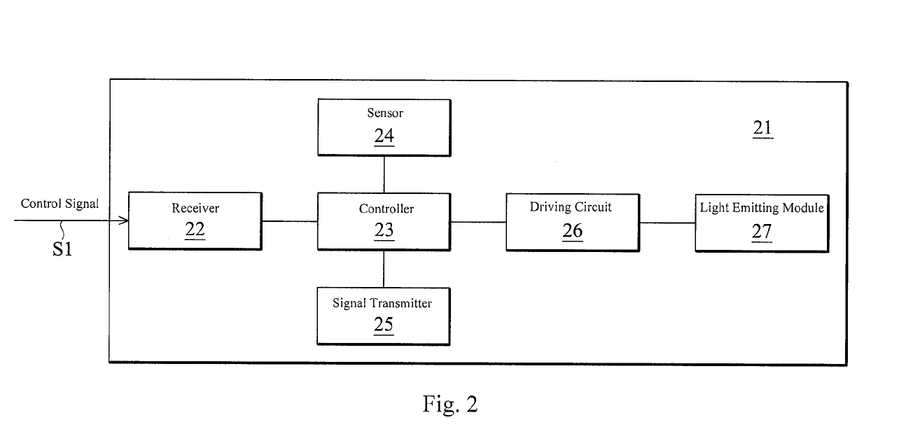

FIG. 2 illustrates a schematic view of a lamp capable of dynamically changing a light emitting mode based on real-time data according to an embodiment of the invention. A lamp 21 includes a receiver 22, a controller 23, a sensor 24, a signal transmitter 25, a driving circuit 26 and a light emitting module 27. The receiver 22 receives a control signal S1 from the handheld device and transmits the control signal S1 to the controller 23. The handheld device generates the control signal S1 according to received real-time information and/or ambient light information and/or a feedback signal transmitted by the lamp 21. The controller 23 determines a light emitting mode of the light emitting module 27 according to the control signal S1 and transmits a corresponding driving signal to the driving circuit 26 according to the light emitting mode. The driving circuit 26 drives the light emitting module 27 according to the driving signal. The sensor 24 is used for sensing an ambient light signal near the lamp 21 and transmits the ambient light signal to the controller 23. The controller 23 generates the feedback signal according to the ambient light signal and transmits the feedback signal to the handheld device via the signal transmitter 25, so that the handheld device generates the control signal S1 according to the feedback signal and the real-time information.

In this embodiment, the signal may be transmitted between the receiver 22/the signal transmitter 25 and the handheld device via microwave, infrared rays, radio wave, Bluetooth, 3G, 4G, WiMAX, ZIGBEE and other wireless communication transmission protocols.

The light emitting module 27 includes a plurality of LEDs, and these LEDs are approximately divided into cold color LEDs and warm color LEDs. According to the control signal S1, the controller 23 controls the light emitting time, luminance and color temperature of the plurality of LEDs in the light emitting module 27 or controls whether the light emitting module is conducted or not. When the controller 23 switches the light emitting mode of the light emitting module 27 to a flash mode, the controller 23 controls the periodic ON/OFF of the light emitting module 27, or controls the cold color LEDs and the warm color LEDs in the light emitting module 27 to be conducted in an alternate order.

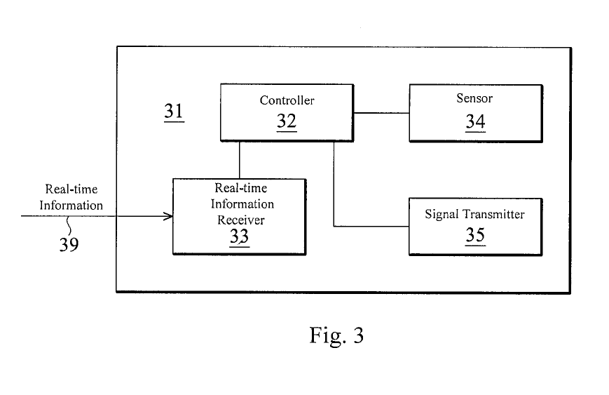

FIG. 3 illustrates a schematic view of a handheld electronic device invention capable of dynamically changing a light emitting mode of a lamp based on real-time data according to an embodiment of the invention. A handheld device 31 includes a controller 32, a real-time information receiver 33, a sensor 34 and a signal transmitter 35. In this embodiment, the signal may be transmitted between the signal transmitter 35 and the lamp via microwave, infrared rays, radio wave, Bluetooth, 3G, 4G, WiMAX, ZIGBEE and other wireless communication transmission protocols.

The real-time information receiver 33 receives real-time information 39 or a message transmitted by an application program in the handheld device from the external and transmits the received signal to the controller 32. The sensor 34 is used for sensing an ambient light signal, including sensing the luminance or the color temperature of the ambient light and transmitting the sensing result to the controller 32. The controller 32 generates a control signal by performing an operation to the ambient light signal and the real-time information 39, and then transmits the control signal to the lamp via the signal transmitter 35.

Although embodiments of the invention are described in the foregoing, they are not intended to limit the invention. That is, simply equivalent variations and modifications made in accordance with the claims and the description of the invention shall still fall within the scope of the invention. In addition, it is not necessary for any embodiment or claim of the invention to achieve all aspects, advantages or features disclosed by the invention. Moreover, the abstract and the title are only used for assisting in patent file retrieval, without limiting the patent right scope of the invention.

What is claimed is:

1. A lamp, comprising:
a light emitting device; and
a controller configured for receiving a control signal from a handheld device and configured for switching the light emitting device according to the control signal such that the light emitting device operates in a light emitting mode corresponding to the control signal, wherein the control signal is generated by the handheld device according to real-time information.

2. The lamp of claim 1, wherein the controller regulates a light emitting time, a luminance and a color temperature of the light emitting device or controls whether the light emitting device is conducted or not according to the light emitting mode.

3. The lamp of claim 1, wherein the real-time information is weather information, a warning signal, time information, or an alarm or a notification message of an application program of the handheld device, and the light emitting device regulates the light emitting mode of the light emitting device according to the real-time information.

4. The lamp of claim 1, wherein the handheld device further comprises a first sensing device for sensing ambient light information, and the handheld device generates and transmits the control signal by performing an operation to the ambient light information and the real-time information.

5. The lamp of claim 1, wherein the lamp further comprises a second sensing device which is arranged in the lamp for sensing second ambient light information and transmitting a feedback signal to the controller and/or the handheld device, so that the handheld device generates and transmits the control signal according to the feedback signal and the real-time information.

6. The lamp of claim 5, wherein the signal is transmitted between the handheld device, the controller and the second sensing device of the lamp via microwave, infrared rays, radio wave, Bluetooth, 3G, 4G, WiMAX, ZIGBEE and other wireless communication transmission protocols.

7. The lamp of claim 1, wherein the light emitting device comprises a cold color light emitting element, a warm color light emitting element, and/or other color light emitting elements, and the flash mode controls the cold color light emitting element and the warm color light emitting element to be conducted in an alternate order.

8. An illuminating system, comprising:
a handheld device, generating a control signal according to received real-time information; and
a lamp, comprising:
a light emitting device; and
a controller for receiving the control signal and switching the light emitting device according to the control signal such that the light emitting device operates in a light emitting mode corresponding to the control signal.

9. The illuminating system of claim 8, wherein the controller regulates a light emitting time, a luminance, a color temperature and a chromaticity coordinate of the light emitting device or controls whether the light emitting device is conducted or not according to the light emitting mode.

10. The illuminating system of claim 8, wherein the real-time information is weather information, a warning signal, time information, or an alarm or a notification message of an application program of the handheld device, and the light emitting device regulates the light emitting mode of the light emitting device according to the real-time information.

11. The illuminating system of claim 8, wherein the handheld device further comprises a first sensing device configured for sensing first ambient light information, and the handheld device further generates and transmits the control signal by performing an operation to the first ambient light information and the real-time information.

12. The illuminating system of claim 8, wherein the illuminating system further comprises a second sensing device which is arranged in the lamp for sensing second ambient light information and transmitting a feedback signal to the controller and/or the handheld device, so that the handheld device generates and transmits the control signal according to the feedback signal and the real-time information.

13. The illuminating system of claim 12, wherein the signal is transmitted between the handheld device, the controller and the second sensing device of the lamp via microwave, infrared rays, radio wave, Bluetooth, 3G, 4G, WiMAX, ZIGBEE and other wireless communication transmission protocols.

14. The illuminating system of claim 8, wherein the light emitting device comprises a cold color light emitting element, and/or other color light emitting elements, and a warm color light emitting element, and the flash mode controls the cold color light emitting element and the warm color light emitting element to be conducted in an alternate order.
